(19) United States
(12) Patent Application Publication
(10) Pub. No.: US 2026/0276535 A1
(43) Pub. Date: Sep. 17, 2026

(54) OPTICAL GAS SENSOR DEVICE

(71) Applicants: Akira NAKAMURA, Tokyo (JP); Masato EHARA, Tokyo (JP)

(72) Inventors: Akira NAKAMURA, Tokyo (JP); Masato EHARA, Tokyo (JP)

(73) Assignee: MITSUMI ELECTRIC CO., LTD., Tokyo (JP)

(21) Appl. No.: 19/469,392

(22) PCT Filed: Mar. 21, 2024
(86) PCT No.: PCT/JP2024/010940

§ 371 Date: Sep. 26, 2025

(30) Foreign Application Priority Data
Mar. 31, 2023 (JP) 2023-059099

(51) Int. Cl. G01N 21/3504

(52) U.S. Cl. CPC G01N 21/3504

(57) ABSTRACT

An optical gas sensor device includes: a light source that emits infrared radiation to a detection target gas; an optical filter that transmits infrared radiation having passed through the detection target gas, the optical filter being a long-pass filter that has a cut-on wavelength shorter than a center wavelength of an absorption wavelength band of the detection target gas and a transmission wavelength including the center wavelength; a light receiver that detects infrared radiation entering the light receiver via the optical filter and generates a detection signal; and an optical cover that covers the light source, the optical filter, and the light receiver. The optical cover includes a pipe-shaped light guide part that guides the entering infrared radiation to the light receiver via the optical filter by reflecting the infrared radiation on an inner surface and that has a circular or oval cross section perpendicular to an axial direction.

### TECHNICAL FIELD

The present invention relates to an optical gas sensor device.

### BACKGROUND ART

Conventionally, gas sensors using a non-dispersive infrared (NDIR) absorption method are known. NDIR gas sensors utilize the property that many gases each absorb a specific infrared wavelength. The NDIR gas sensor emits infrared radiation to a detection target gas, detects the absorbed wavelength and the absorbed amount, and measures the concentration of the detection target gas. For example, the gas sensor includes an infrared light emitter and an infrared light receiver and detects the concentration of the detection target in an optical path between the light emitter and the light receiver.

For an air conditioner using a refrigerant, a known refrigerant leak detection device detects the concentration of the refrigerant using an infrared sensor and thereby detects leakage of the refrigerant (see Patent Document 1). The infrared sensor includes a light emitter, a light receiver disposed to face the light emitter, and an optical filter provided between the light emitter and the light receiver. The optical filter transmits a specific infrared wavelength range that is absorbed by the refrigerant.

### CITATION LIST

### Patent Literature

Patent Document 1: Japanese Unexamined Patent Application Publication No. 2018-28392

### SUMMARY OF INVENTION

### Technical Problem

According to the refrigerant leak detection device of Patent Document 1, the light emitter and the light receiver are arranged to face each other. Therefore, the incidence angle of infrared radiation to the optical filter and the light receiver is nearly 0°. To increase the length of the optical path in which a gas reacts with infrared radiation and to downsize the gas sensor, the optical path of infrared radiation from the light emitter to the light receiver may be configured to reflect infrared radiation. In such a reflective path, a greater proportion of infrared radiation enters the light receiver at incidence angles other than 0°.

The optical filter of a gas sensor is typically a band-pass filter. The band-pass filter transmits infrared radiation having a wavelength corresponding to maximum absorption in the absorption spectrum of a detection target gas. However, as the incidence angle of infrared radiation entering the light receiver via the band-pass filter deviates from 0°, the center wavelength of the absorption wavelength band of infrared radiation shifts to a shorter wavelength side, and the frequency band corresponding to infrared absorption deviates from the transmission frequency band of the band-pass filter. As a result, the light receiver detects a less amount of light. This may lead to a decrease in detection accuracy of the detection target gas.

An object of the present invention is to increase detection accuracy of a detection target gas using infrared radiation passing through a reflective optical path.

### Solution to Problem

To achieve the above object, according to the present invention, an optical gas sensor device includes: a light source that emits infrared radiation to a detection target gas; an optical filter that transmits infrared radiation having passed through the detection target gas, the optical filter being a long-pass filter that has a cut-on wavelength shorter than a center wavelength of an absorption wavelength band of the detection target gas and a transmission wavelength including the center wavelength; light receiver that detects infrared radiation entering the light receiver via the optical filter and generates a detection signal; and an optical cover that covers the light source, the optical filter, and the light receiver, wherein the optical cover includes a pipe-shaped light guide part that guides infrared radiation entering from the light source to the light receiver via the optical filter by reflecting the infrared radiation on an inner surface and that has a circular or oval cross section perpendicular to an axial direction.

Further, according to the present invention, an optical gas sensor device includes: a light source that emits infrared radiation to a detection target gas; an optical filter that transmits infrared radiation having passed through the detection target gas, the optical filter being a band-pass filter, a center wavelength of transmittance at vertical incidence (θ=0°) of the optical filter being shifted by a predetermined shift amount to a longer wavelength side from a wavelength corresponding to maximum absorption in an absorption spectrum of the detection target gas; a light receiver that detects infrared radiation entering the light receiver via the optical filter and generates a detection signal; and an optical cover that covers the light source, the optical filter, and the light receiver, wherein the optical cover includes a pipe-shaped light guide part that guides infrared radiation entering from the light source to the light receiver via the optical filter by reflecting the infrared radiation on an inner surface and that has a circular or oval cross section perpendicular to an axial direction.

### Advantageous Effects of Invention

According to the present invention, it is possible to increase detection accuracy of a detection target gas using infrared radiation passing through a reflective optical path.

### BRIEF DESCRIPTION OF DRAWINGS

FIG. 1 This is a schematic diagram of an optical gas sensor device according to a first embodiment of the present invention.

FIG. 2 This is a perspective view of the optical gas sensor device.

FIG. 3 This is a transparent perspective view of an optical cover, a light source, an optical filter, and a light receiver.

FIG. 4 This is a perspective view of the light source.

FIG. 5 This is a plan view of the optical gas sensor device.

FIG. 6A This is a cross-sectional view of the optical gas sensor device in the first embodiment.

FIG. 6B This is a cross-sectional view of the optical gas sensor device in a modification example.

FIG. 7 This is a diagram showing distribution of light incidence angles to the light receiver.

FIG. 8 This is a diagram showing transmission characteristics of a long-pass filter.

FIG. 9 This is a diagram showing angular dependence of transmittance of the long-pass filter.

FIG. 10 This is a diagram showing transmission characteristics of a conventional band-pass filter.

FIG. 11 This is a diagram showing angular dependence of transmittance of the conventional band-pass filter.

FIG. 12 This is a diagram showing absorption wavelengths of multiple kinds of gases.

FIG. 13 This is a diagram showing transmission characteristics of an optical filter of a first practical example.

FIG. 14 This is a diagram showing transmission characteristics of an optical filter of a first comparative example.

FIG. 15 This is a diagram showing transmission characteristics of the optical filter of the first practical example and absorption spectra of R32 and R1234yf.

FIG. 16 This is a diagram showing transmission characteristics of a conventional band-pass filter.

FIG. 17 This is a diagram showing transmission characteristics of a band-pass filter in a second embodiment.

FIG. 18 This is a diagram showing transmission characteristics of a band-pass filter of an example and the center wavelength of transmittance.

### DESCRIPTION OF EMBODIMENTS

Hereinafter, a first embodiment and its practical example and a second embodiment of the present invention will be described in detail in order with reference to the accompanying drawings. However, the scope of the invention is not limited to the illustrated examples.

### First Embodiment

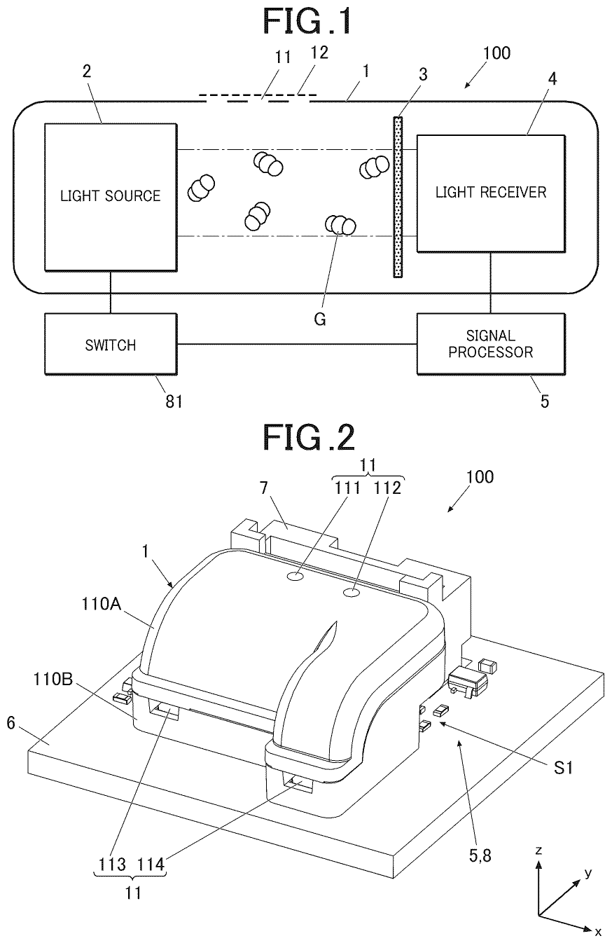

The first embodiment of the present invention is described with reference to FIG. 1 to FIG. 15. A schematic configuration of an optical gas sensor device 100 according to the present embodiment is described with reference to FIG. 1. FIG. 1 is a schematic diagram of the optical gas sensor device 100 in this embodiment.

As illustrated in FIG. 1, the optical gas sensor device 100 in this embodiment includes an optical cover 1, a light source 2, an optical filter 3, a light receiver 4, a signal processor 5, and a switch 81. The optical gas sensor device 100 is an NDIR gas sensor. The light source 2 radiates infrared radiation (emits light) toward a detection (measurement) target gas G in the optical cover 1 through an optical path (course) inside the optical cover 1. The molecules of the detection target gas G in the optical path absorb the infrared radiation, so that a less amount of light reaches the light receiver 4. The light receiver 4 detects, via the optical filter 3, the infrared radiation partially absorbed by the detection target gas G. The signal processor 5 processes the detection signal, detects (measures) the concentration of the detection target gas G, and outputs the concentration. The switch 81 is for turning on/off light emission of the light source 2. The switch 81 is included in circuit elements 8 described later. The signal processor 5 turns on the light source 2 via the switch 81 when gas detection is performed. The signal processor 5 turns off the light source 2 via the switch 81 when gas detection is ended. The optical cover 1 has gas introduction ports 11 as gas introduction parts that are inlets/outlets of the detection target gas G. To prevent entrance of external foreign matters, a contamination filter 12 (e.g., a metal mesh filter or a porous resin film) is put on the gas introduction ports 11.

Specifically, according to the optical gas sensor device 100, the optical filter 3 filters infrared radiation emitted from the light source 2 toward the detection target gas G, and the light receiver 4 receives the filtered infrared radiation. The optical filter 3 is disposed near the light receiver 4 in the upstream of the light receiver 4 on the optical path. Since filtering is performed on the light receiving surface of the light receiver 4 in this configuration, the area of the optical filter 3 is reduced and cost is reduced, as compared with a configuration in which infrared radiation from by the light source 2 is filtered by the optical filter and thereafter emitted toward the detection target gas G. Further, since the light receiver 4 does not receive unfiltered infrared radiation emitted by sources other than the light source 2, the signal-to-noise ratio (SN ratio) as a sensor increases. However, the optical gas sensor device 100 may be configured to filter infrared radiation emitted by the light source 2 with the optical filter 3 and thereafter irradiate the detection target gas G with the filtered infrared radiation. In this embodiment, the optical path is designed such that infrared radiation to be received by the light receiver 4 via the optical filter 3 is reflected on the inner surface of the optical cover 1 before reaching the light receiver 4, instead of directly reaching the light receiver 4 from the light source 2. It is preferable that the inner surface of the optical cover 1 have a high reflectance to increase light (infrared radiation) use efficiency.

As the detection target gas G, the optical gas sensor device 100 detects an alternative refrigerant(s) for chlofluorocarbons used in air conditioners. The alternative for chlofluorocarbons (CFCs) is a synthetic compound (gas) refrigerant used in industry as an alternative for specified CFCs. Since the CFC refrigerants have high ozone-depleting potentials and cause depletion of the ozone layer of the earth, replacement of the CFC refrigerants with hydrochlorofluorocarbon (HCFC) refrigerants having lower ozone-depleting potentials has been started. Further, developed countries have proceeded with replacement of the HCFC refrigerants with a HFC refrigerant (R410A) that has zero ozone-depleting potential.

The CFC refrigerants, HCFC refrigerants, and the HFC refrigerant are known to have high global warming potential and cause global warming as greenhouse gases. Therefore, replacement of the HFC refrigerant (R410A) with a HFC refrigerant (R32) having a lower global warming potential has been considered.

The detection target gas G in this embodiment is an alternative refrigerant for CFCs. The following table I shows a product group of air conditioners (product types) and their corresponding major refrigerants conventionally used, alternative refrigerants having been used, and refrigerants under investigation as alternatives.

TABLE I

| | Major | Alternative | Refrigerants |
|---|---|---|---|
| | refrigerants | refrigerants | under |
| | conventionally | having | investigation |
| Product group | used | been used | as alternative |
| Room air conditioner | R410A, R32 | R32 | R454C, R290 |
| Air conditioner for store and office | R410A, R407C, | R32 | R1123 |
| | R32 | | Mixed system |
| Multi air conditioner for building | R410A, R407C | | R32, R466A |
| Chilling unit | R134a, R410A, | | R466A |
| | R404A | | |
| Centrifugal chiller | R123, R245fa, | | R1233zd, 1224yd, |
| | R134a | | R1234ze, R514A |
| Refrigerated showcase, | R410A, R404A | R744 | R463A, R448A, |
| Condensing unit | | | R468A |
| Refrigerated warehouse | R22 | R717, R717/R744, | |
| | | Air | |
| Vending machine | R410A, R404A | R744, R600a | |
| Heat pump water heater | R744, R410A | | R454C |
| Refrigerator-freezer for home use | R134a, R600a | | |
| Car air conditioner | R134a | R1234yf | |

Specific examples of the detection target gas G in this embodiment are listed in the following Table II.

TABLE II

| | | | | Lower |
|---|---|---|---|---|
| Refrigerant | | | Flammability | flammability |
| name | Substance name | Chemical formula | classification | limit [kg/m³] |
| ◯ R32 | Difluoromethane | CH₂F₂ | A2L | 0.307 |
| R50 | Methane | CH₄ | A3 | 0.032 |
| ◯ R143a | 1,1,1-Trifluoroethane | CF₃CH₃ | A2L | 0.282 |
| ◯ R152a | 1,1-Difluoroethane | CHF₂CH₃ | A2 | 0.130 |
| R170 | Ethane | CH₃CH₃ | A3 | 0.038 |
| R290 | Propane | CH₃CH₂CH₃ | A3 | 0.038 |
| R600 | n-Butane | CH₃CH₂CH₂CH₃ | A3 | 0.038 |
| R600a | Isobutane | CH(CH₃)₃ | A3 | 0.043 |
| R1150 | Ethylene | CH₂═CH₂ | A3 | 0.036 |
| ◯ R1132 | 1,1-Difluoroethylene | CF₂═CH₂ | A2 | 0.131 |
| R1270 | Propylene | CH₂═CHCH₃ | A3 | 0.046 |
| RE170 | Dimethylether | (CH₃)₂O | A3 | 0.064 |
| ◯ R142b | 1-chroloro-1,1- | CH₃CCIF₂ | A2L | 0.329 |
| | difluoroethane | | | |
| ◯ R1234yf | 2,3,3,3-tetrafluoro- | CF₃CF═CH₂ | A2L | 0.289 |
| | 1-propene | | | |
| ◯ R1234ze(E) | Trans-1,3,3,3- | CF₃CF═CHF | A2L | 0.303 |
| | tetrafluoro-1-propene | | | |
| ◯ R-444A | R-32/152a/1234ze(E) | (12.0/5.0/83.0) | A2L | 0.324 |
| ◯ R-444B | R-32/152a/1234ze(E) | (41.5/10.0/48.5) | A2L | 0.277 |
| ◯ R-445A | R-744/134a/1234ze(E) | (6.0/9.0/85.0) | A2L | 0.341 |
| ◯ R-446A | R-32/1234ze(E)/600 | (68.0/29.0/3.0) | A2L | 0.236 |
| ◯ R-447A | R-32/125/1234ze(E) | (68.0/3.5/28.5) | A2L | 0.304 |
| ◯ R-447B | R-32/125/1234ze(E) | (68.0/8.0/24.0) | A2L | 0.312 |
| ◯ R-451A | R-1234yf/134a | (89.8/10.2) | A2L | 0.322 |
| ◯ R-451B | R-1234yf/134a | (88.8/11.2) | A2L | 0.322 |
| ◯ R-452B | R-32/125/1234yf | (67.0/7.0/26.0) | A2L | 0.309 |
| ◯ R-454A | R-32/1234yf | (35.0/65.0) | A21 | 0.273 |
| ◯ R-454B | R-32/1234yf | (68.9/31.1) | A2L | 0.307 |
| ◯ R-454C | R-32/1234yf | (21.5/78.5) | A2L | 0.286 |
| ◯ R-455A | R-744/32/1234yf | (3.0/21.5/75.5) | A2L | 0.422 |
| ◯ R-457A | R-32/1234yf/152a | (18.0/70.0/12.0) | A2L | 0.215 |
| ◯ R-459A | R-32/1234yf/1234ze(E) | (68.0/26.0/6.0) | A2L | 0.276 |
| ◯ R-459B | R-32/1234yf/1234ze(E) | (21.0/69.0/10.0) | A2L | 0.369 |
| ◯ R-462A | R-32/125/143a/134a/600 | (9.0/42.0/2.0/44.0/3.0) | A2L | 0.230 |
| ◯ R-465A | R-32/290/1234yf | (21.0/7.9/71.1) | A2L | 0.159 |

The flammability classification in Table II indicates toxicity and flammability. “A” indicates low toxicity. “2L” indicates low flammability. “2” indicates flammability. “3” indicates high flammability. Refrigerants having a circle mark on the left of their names are the refrigerants as the detection target gases G. The detection target gas G is a refrigerant consisting of a single kind of molecule that contains at least one fluorine (F) atom or a refrigerant as a mixture of multiple kinds of such molecules having different structures. Further, the detection target gas G is a refrigerant classified as “A2L” or greater in the flammability classification.

The alternatives for CFCs show maximum absorption at around 9 μm. For example, R32 shows maximum absorption at 9.1 μm, which is the center wavelength of the absorption wavelength band. This absorption wavelength band originates from the C—F bond unique to CFCs. Using this absorption wavelength band can prevent interference of absorption by other gases. Therefore, as a requirement for the detection target gas G, the detection target gas G is an alternative for CFCs that contains a single kind of molecule containing at least one fluorine (F) atom or that contains a mixture of multiple kinds of such molecules having different structures.

It is important to detect gases the lower flammability limits of which are low and the flammability levels of which are high in Table II to avoid accidents, such as combustion of leaked gas. Therefore, as a requirement for the detection target gas G, the detection target gas G is a refrigerant having a flammability classification level greater than or equal to A2L.

It is preferable that the optical gas sensor device 100 detect absorption of infrared radiation having a wavelength corresponding to maximum absorption among absorption wavelengths of the detection target gas G. For example, to detect R32 as the concentration detection target gas G, the optical gas sensor device 1 detects absorption of 9.1 μm infrared radiation, which is the center wavelength of the maximum absorption wavelength band among multiple absorption wavelength bands.

The signal processor 5 outputs various state signals, based on the concentration of the detected gas G, and the concentration of the gas G as a detection signal (output voltage) of the light receiver 4 or the value corresponding to the concentration to an apparatus, such as a processor of an air conditioner. The various state signals are, for example, a malfunction signal indicating a malfunction state of the optical gas sensor device 100, a warning signal indicating an abnormal state (warning state) in which the concentration of the detected gas G needs to be warned, and a monitoring signal (normal signal) indicating that the concentration of the detected gas G is in a normal state.

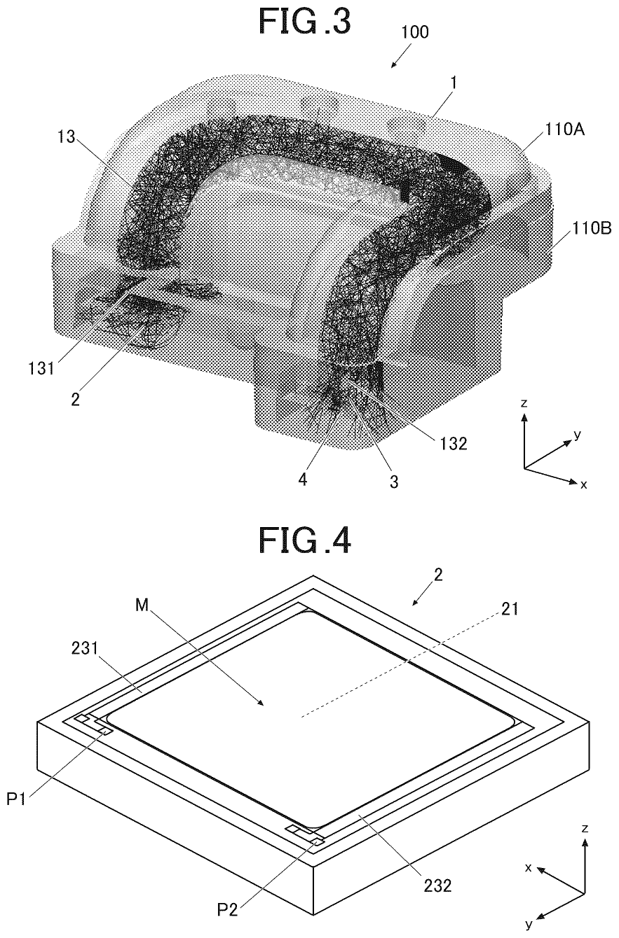

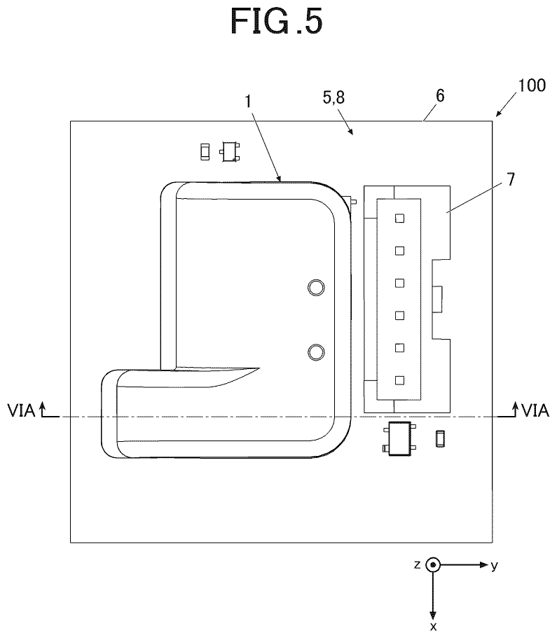

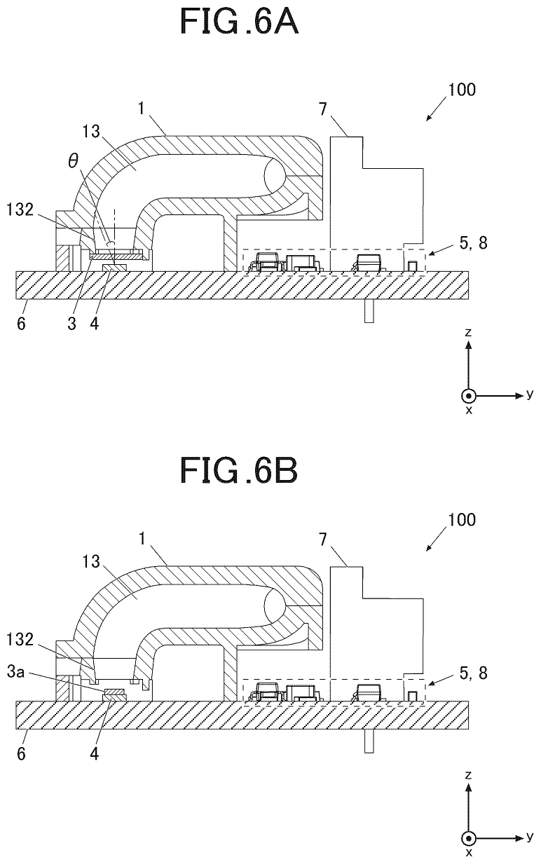

Next, a detailed configuration of the optical gas sensor device 100 is described with reference to FIG. 2 to FIG. 6. FIG. 2 is a perspective view of the optical gas sensor device 100. FIG. 3 is a transparent perspective view of the optical cover 1, the light source 2, the optical filter 3, and the light receiver 4. FIG. 4 is a perspective view of the light source 2. FIG. 5 is a plan view of the optical gas sensor device 100. FIG. 6A is a cross-sectional view of the optical gas sensor device 100. FIG. 6B is a cross-sectional view of the optical gas sensor device 100 in a modification example.

As illustrated in FIG. 2 and FIG. 3, the optical gas sensor device 100 includes the optical cover 1, the light source 2, the optical filter 3, the light receiver 4, the signal processor 5, a board 6, a connector 7, and circuit elements 8, for example. In FIG. 2 and FIG. 3, x, y, and z axes in three-dimensional space are shown. These three axes are also shown in FIG. 4 to FIG. 6B. Illustration of the contamination filter 12 is omitted in FIG. 2, FIG. 3, and FIG. 5 to FIG. 6B.

The optical cover 1 is mounted on the +z side surface of the board 6 to cover (house) the light source 2, the optical filter 3, and the light receiver 4. The optical cover 1 forms a hollow part (space) in which the detection target gas G can be accommodated. The detection target gas G is let into and let out from the hollow part of the optical cover 1 through the gas introduction ports 11. The base body of the optical cover 1 is made of resin, for example.

As shown in FIG. 2, the optical cover 1 includes cover parts 110A and 110B. The cover part 110A is an upper side (+z direction side) part and is fitted to and integrated with the cover part 110B by bonding, heat staking, or the like. The cover part 110B is a lower side (−z direction side) part and is fitted to and integrated with the cover part 110A by bonding, heat staking, or the like.

As shown in FIG. 3, the optical cover 1 includes a light guide part 13 as a hollow part into which the detection target gas G is introduced. The light guide part 13 is a pipe-shaped light path. The cross section of the light guide part 13 perpendicular to the axial direction is circular. The cover part 110A has a half-pipe section. The cover part 110B has a half-pipe section. By the combination of the half-pipe sections of the cover part 110A and the cover part 110B, the light guide part 13 is formed. Thus, the optical cover 1 has the cover parts 110A and 110B into which the optical cover 1 is divided at the cross section in the axial direction of the light guide part 13. As shown in FIG. 3, the light guide part 13 is substantially U-shaped in three dimensions when viewed from the top surface (+z direction side surface).

The inner surface of the light guide part 13 is covered with an infrared reflective film. The infrared reflective film in this embodiment is gold but is not limited to gold. The infrared reflective film may be silver, aluminum, a dielectric multilayer membrane, or a multilayer membrane made of infrared transmissive material, such as Si, Ge, a sulfide, or a fluoride. If necessary, a protective film made of silicon oxide, silicon nitride, or the like may be formed on the infrared reflective film to prevent corrosion of the metal film of the infrared reflective film. The infrared reflective film and the protective film can be formed by plating, sputtering, vacuum vapor deposition, or the like. The optical cover 1 may be unitarily made of metal, such as aluminum, by a metal 3D printer, for example.

The light guide part 13 reflects, on the infrared reflective film of its inner surface, infrared radiation entering from the light source 2 and delivers the infrared radiation to the light receiver 4 via the optical filter 3. Thus, by reflecting the infrared radiation emitted by the light source 2 on the infrared reflective film, the optical cover 1 plays a role as the optical path that efficiently guides infrared radiation from the light source 2 to the light receiver 4 such that at least part of the reflected light reaches the light receiver 4 via the optical filter 3.

In this embodiment, the pipe-shaped light guide part 13 having a circular cross section serves as the light path in the optical cover 1. Such a light guide part 13 keeps the reflection angle of infrared radiation at a constant angle in any three dimensional direction (x, y, and z axes), regardless of the diameter of the cross section of the light guide part 13 or the path in the light guide part 13. Therefore, infrared radiation emitted by the light source 2 can efficiently enter the light receiver 4 after being reflected inside the light guide part 13.

The length of the infrared optical path from the light source 2 to the light receiver 4 can be changed relatively easily by changing the diameter of the cross section of the light guide part 13.

As illustrated in FIG. 2 and FIG. 3, the optical cover 1 is three-dimensionally designed and formed such that a space S1 is formed on the board 6 below (in the −z direction) a portion of the light guide part 13 in the x-axis direction. At least part of the signal processor 5 and the circuit elements 8 is placed in the space S1 and mounted on the board 6.

The cross-sectional area of the light guide part 13 perpendicular to the axial direction is uniform in the axial direction at main parts except an entrance part 131 and an exit part 132, which are described later. Since the light guide part 13 has a uniform cross-sectional area, the gas concentration per unit volume of the detection target gas G in the light guide part 13 is easily equalized. Further, since infrared radiation randomly passes through the light guide part 13 instead of passing through a specific path, the optical gas sensor device 100 can easily react a change in the gas concentration of the gas G. FIG. 3 illustrates how the light paths of infrared radiation spread in the light guide part 13. The light paths are shown by solid lines. The light paths of infrared radiation spread randomly in the light guide part 13 as illustrated.

The light emitted by the light source 2 enters the light guide part 13 at the −x direction side. The axial direction of the light guide part 13 at the −x direction side extends from the −z direction side to the +z direction side, then bends in an R shape, and linearly extends from the −y direction side to the ty direction side. The end of the light guide part 13 at the infrared radiation entering side is defined as the entrance part 131. The light guide part 13 extends in the +y direction and bends in an R shape, and its axial direction extends from the −x direction side to the +x direction side and again bends in an R shape.

At the +x direction side, the axial direction of the light guide part 13 linearly extends from the +y direction side to the −y direction side, then bends in an R shape, and extends in the −z direction. Infrared radiation that has passed through the light guide part 13 is emitted to the optical filter 3 and the light receiver 4. The end of the light guide part 13 at the infrared radiation emission side is defined as the exit part 132.

The cover parts 110A and 110B have not-illustrated hollow parts as spaces for weight reduction. With these hollow parts, the optical cover 1 (optical gas sensor device 100) can be made lightweight.

The cover part 110B has not-illustrated fixing pins. The fixing pins are protrusions extending in the +z direction. The fixing pins are fitted to not-illustrated recesses (internal holes) of the cover part 110A and integrated by bonding, heat staking, or the like. By fixing and integrating the fixing pins into the recesses of the cover part 110A by bonding, heat staking, or the like, the positions of the cover parts 110A and 110B are fixed, and the cover parts 110A and 100B are formed as a unitary part.

As illustrated in FIG. 2, the cover part 110A has gas intake ports 111, 112 as gas introduction ports 11. The cover part 110B has gas intake ports (gas introduction holes) 113, 114 as gas introduction ports 11. The gas intake ports 111, 112 are holes formed in the −z direction from the top surface of the cover part 110A and penetrating to the light guide part 13. The gas intake port 113 is a hole formed in the +y direction from the −y direction side surface of the cover part 110B and penetrating to the space around the light source 2 (the space next to the light source 2). The space around the light source 2 communicates to the light guide part 13. The gas intake port 114 is a hole formed in the ty direction from the −y direction side surface of the cover part 110B and penetrating to the space around the optical filter 3 and the light receiver 4 (the space next to the optical filter 3 and the light receiver 4). The space around the optical filter 3 and the light receiver 4 communicates to the light guide part 13.

The gas intake ports 111, 112 directly communicate to the light guide part 13. Since part of the inner surface of the light guide part 13 is removed, the efficiency in using infrared radiation decreases. On the other hand, the gas intake port 113 indirectly communicates to the light guide part 13 through the space around the light source 2. Therefore, part of the inner surface of the light guide part 13 is not damaged (removed), and the efficiency n using infrared radiation increases. Similarly, since the gas intake port 114 indirectly communicates to the light guide part 13 through the space around the optical filter 3 and the light receiver 4, part of the inner surface of the light guide part 13 is not damaged (removed), and the efficiency in using infrared radiation increases.

The shapes, sizes, and positions of the gas introduction ports 11 (gas intake ports 111, 112, 113, and 114) of the optical cover 1 in FIG. 2 are examples and are not limitations.

As shown in FIG. 4, the light source 2 is a micro electro mechanical systems (MEMS) type light source mounted on the top surface (the +z side surface) of the board 6, and a membrane M having a membrane structure is formed, for example. The light source 2 includes: an electrode 231 and a pad P1 provided at the +x direction side; and an electrode 232 and a pad P2 provided at the −x direction side.

The light source 2 includes, as the membrane M provided on a Si substrate, a structure in which a light-source layer support layer, a light-source layer 21, an electrode support layer, and a protection layer (none of which are illustrated) are stacked from the −z direction side to the +z direction side, for example. The light-source layer support layer includes, for example, a silicon oxide film, a silicon nitride film, and a high-temperature low-pressure dielectric (HLD) layer from the −z direction side to the +z direction side, for example. The light-source layer 21 is a thin-film heater as a light source (metal) layer (light emitting layer) that radiates infrared radiation. The light-source layer 21 consists of MoSi₂, for example. When the membrane M is heated by energization, the light-source layer radiates infrared radiation having wavelength dependence and intensity that depends on a surface temperature and a surface emissivity. The electrode support layer includes two insulator layers from the −z direction side to the +z direction side, for example, and supports the electrodes. The protection layer consists of an insulator and protects the top surface.

The light-source layer 21 is electrically connected to the electrodes 231 and 232. The pad P1 is for wire bonding and is electrically connected to the electrode 231. The pad P2 is for wire bonding and is electrically connected to the electrode 232. The pads P1 and P2 are wire-bonded to the terminals of wiring patterns on the board 6. By the application of voltage, the light source layer 21 is energized to emit infrared radiation.

The small and low-profile light source 2 as a MEMS-type light source contributes to a compact sensor module. Characteristically, the light source 2 as the MEMS-type light source has a long life, low power consumption, and short response time, and thereby contributes to reducing power consumption of the entire sensor module. When intermittent driving is performed, the short response time of the MEMS-type light source enables a short standby time after energization and thereby reduces average power consumption.

The light source 2 as the MEMS-type light source can directly utilize light emitted from the surface of a high-temperature part and is therefore applicable to detection of gases having absorption bands at high wavelengths. Further, since the infrared radiation emitting region of the light source 2 is precisely patterned on the surface of the Si substrate of the membrane M, there are very small individual variations in the emitting direction. Accordingly, the light source 2 constituting the sensor module contributes to small variations in the light receiving amount and a large product yield. Further, since the light source 2 is produced in bulk from silicon wafers by the MEMS technology, the light source 2 is excellent in mass production.

The light source 2 is a surface-mounted component but is not limited to this. The light source 2 may be a dual inline package (DIP) component (e.g., CAN package).

The optical filter 3 is provided to cover the light receiving surface of the light receiver 4. The optical filter 3 transmits light (infrared radiation) having a wavelength range (band) corresponding to the absorption wavelength specific to the detection target gas G. Thus, the transmission wavelength of the optical filter 3 is designed to match the absorption wavelength specific to the detection target gas G. Such an optical filter 3 suppresses changes in light intensity caused by gases other than the detection target gas G and improves the SN ratio of detection signals of the light receiver 4.

The optical filter 3 includes, for example, a silicon substrate as a substrate and a dielectric multilayer film or a multilayer film made of infrared transmissive material, such as Si, Ge, sulfide, and fluoride. The silicon substrate is a flat silicon substrate. The material of the substrate is not limited to silicon but can be Ge (germanium), quartz, alumina, BaF₂ (barium fluoride), CaF₂ (calcium fluoride), or the like. The multilayer film consists of layers provided on both sides of the silicon substrate. The flat shape of the optical filter 3 is rectangular but is not limited to this. The optical filter 3 may have a different flat shape, such as a circular shape.

The optical filter 3 in this embodiment is a long-pass filter that cuts off light having wavelengths shorter than a certain wavelength and transmits light having longer wavelengths, instead of a band-pass filter that transmits only wavelengths in a specific frequency band, as described later.

The light receiver 4 is mounted on the +z side surface of the board 6. The light receiver 4 is a thermopile-type light sensor (infrared sensor) having thermocouples. The light receiver 4 detects the intensity of incident infrared radiation and outputs a detection signal as an analog electric signal. However, the light receiver 4 is not limited to the thermopile-type infrared sensor. The light receiver 4 may be an infrared sensor of various types shown in the following Table III.

TABLE III

| | | | Detection | |
|---|---|---|---|---|
| Operating principle | | | wavelength | Element material |
| Quantum | External | Photoelectric | UV | Cesium silver oxide (Ag—O—Cs) |
| type | photoelectric | tube | rays ~0.9 | Gallium arsenide cesium (GaAs—Cs) |
| (Cooling | effect | | [μm] | |
| type) | Internal | Photoconductive | 3~5 | Mercury cadmium telluride (HgCdTe) |
| | photoelectric | type | [μm] | Indium antimonide (InSb) |
| | effect | | 8~12 | Mercury cadmium telluride (HgCdTe) |
| | | | [μm] | Gallium arsenide (GaAs) |
| | | | | Aluminum gallium arsenide (AlGaAs) |
| | | | | Quantum well infrared photodetector |
| | | | | (QWIP) |
| | | Photovoltaic | 3~5 | Platinum silicon (PrSi) |
| | | type | [μm] | Indium antimonide (InSb) |
| | | | 8~12 | Mercury cadmium telluride (HgCdTe) |
| | | | [μm] | Germanium silicon (GeSi) |
| Thermal | Pyroelectric | Pyroelectric | 1~3 | Lead sulfide (PbS) |
| type | effect | sensor type | [μm] | |
| (Non- | | | 8~12 | Barium strontium titanate (BST) |
| cooling | | | [μm] | Lead zirconate titanate (PZT) |
| type) | Thermoelectric | Thermocouple | | Polycrystalline silicon (Poly-Si) |
| | effect | type | | |
| | Effect of change | Bolometer type | | Vanadium oxide (VOx) |
| | in electrical | | | Giant magneto resistive effect (CMR) |
| | resistance by | | | Yttrium-based superconductor (YBCO) |
| | temperature | | | Amorphous silicon (a-Si) |

The light receiver 4 is a surface-mounted component but is not limited to this. The light receiver 4 may be a DIP component t (e.g., CAN package). The light guide part 13 can efficiently obtain light intensity regardless of the orientation of the light source 2 and light receiver 4, namely regardless of whether the light source 2 and light receiver 4 are surface-mounted components or DIP components.

FIG. 5 illustrates a planar configuration of the optical gas sensor device 100 and the cut line VIA-VIA parallel to the y-axis direction of the optical cover 1. FIG. 6A illustrates a lateral view of a sectional configuration of the optical cover 1 cut along the cut line VIA-VIA. The position of the optical filter 3 should be in the light guide part 13, which is the light path extending from the light source 2 to the light receiver 4.

As illustrated in FIG. 6A, the end of the light guide part 13 at the infrared radiation emission side is defined as the exit part 132. The optical filter 3 is disposed directly below (below and near) the exit part 132 such that the flat surface of the optical filter 3 is parallel to the xy plane (parallel to the surface of the light receiver 4). In such a configuration, the optical filter 3 is joined to the bottom surface of the exit part 132, for example. The area of the optical filter 3a covers at least the cross section in the axial direction of the exit part 132.

The position of the optical filter 3 is not limited to the position in FIG. 6A. For example, as illustrated in FIG. 6B, the optical filter 3a instead of the optical filter 3 may be disposed below the exit part 132 such that the flat surface of the optical filter 3a is parallel to the xy plane and near the surface (light receiving surface) of the light receiver 4. In such a configuration, the optical filter 3a is joined to the top surface of the light receiver 4, for example. The area of the optical filter 3a covers at least the light receiving surface at the top surface of the light receiver 4. That is, the area of the flat surface of the optical filter 3a is smaller than the area of the flat surface of the optical filter 3.

The exit part 132 has a tapered shape, and the cross-sectional area of the exit part 132 becomes smaller toward the −z direction side from the +z direction side along the axial direction of the light guide part 13. Similarly, the entrance part 131 has a tapered shape, and the cross-sectional area of the entrance part 131 becomes smaller toward the −z direction side from the +z direction side along the axial direction of the light guide part 13. Such shapes can increase the intensity of infrared radiation that passes through the light guide part 13 and radiates toward the light receiver 4.

The signal processor 5 is mounted on the +z-direction side flat surface region of the board 6. The signal processor 5 is an AFE (Analog Front End)—IC (Integrated Circuit) as an electronic element (processor) that performs signal processing related to detection signals of the light receiver 4. The signal processor 5 amplifies analog detection signals of the light receiver 4, performs AD conversion, and performs correction of individual variations in the optical gas sensor device 100 and so forth. By using the amplified digital detection signals, the signal processor 5 performs signal processing (calculation of a gas concentration or a value corresponding to the gas concentration and the state of the optical gas sensor device 100, generation of various signals thereof) and generates and outputs various digital signals.

The board 6 is a printed circuit board (PCB) formed of a glass epoxy resin plate or the like on which conductor wiring is printed. The optical cover 1, the light source 2, the light receiver 4, the signal processor 5, the connector 7, and the circuit elements 8 are mounted on the top surface (+z side surface) of the board 6.

The connector 7 is mounted on the +z-direction side flat surface region of the board 6 other than the optical cover 1 and the signal processor 5. The connector 7 outputs various digital signals output by the signal processor 5 to an information processor of a post-stage apparatus (e.g., warning device). The connector 7 is a receptacle connector to which a cable with a plug is connected. The connector 7 is connected to the information processor of the above apparatus via the cable.

The circuit elements 8 include the switch 81, chip resistors, and chip capacitors mounted on the +z direction side flat surface region of the board 6.

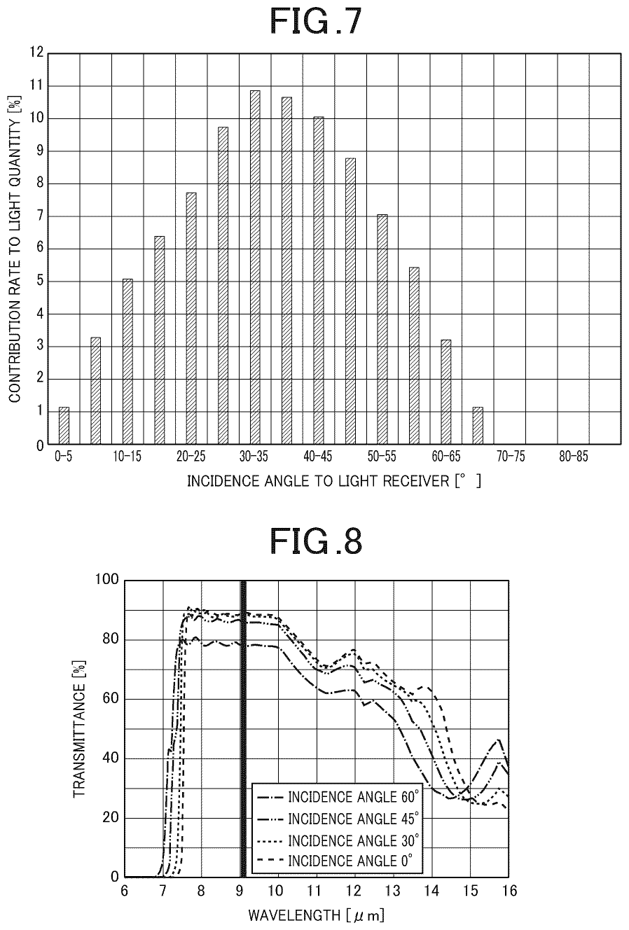

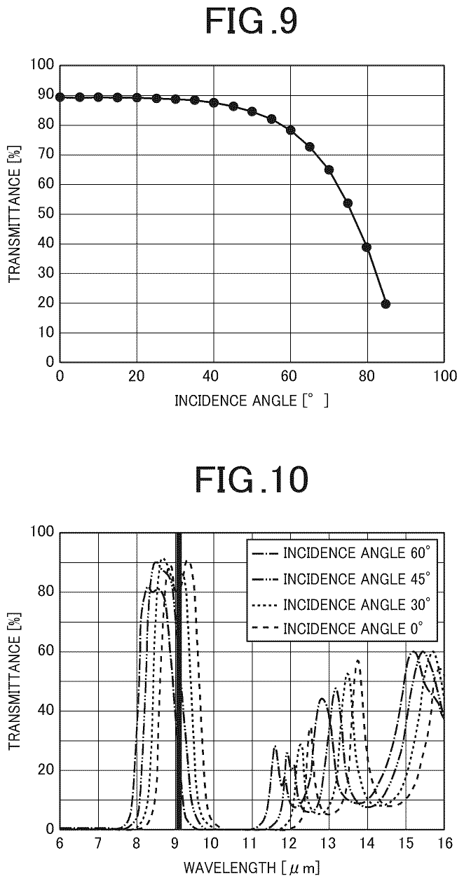

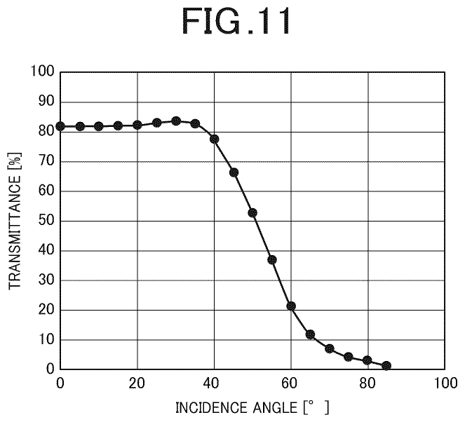

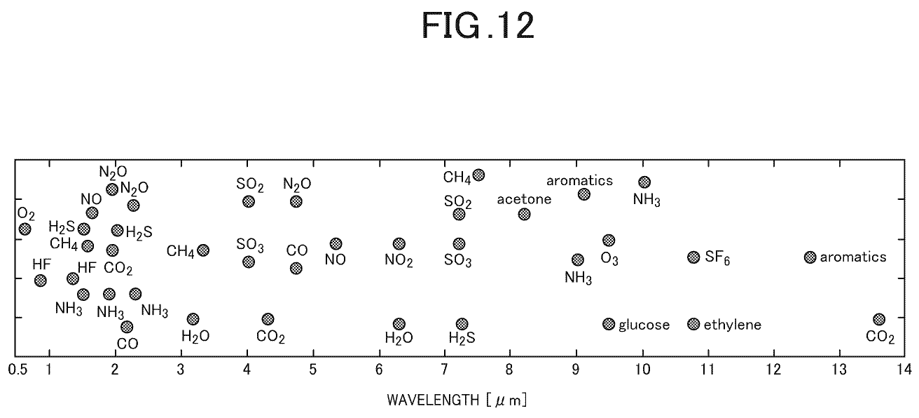

Next, the characteristics of the optical filter 3 and the optical gas sensor device 100 are described with reference to FIG. 7 to FIG. 12. FIG. 7 is a diagram showing distribution of light incidence angles to the light receiver 4. FIG. 8 is a diagram showing transmission characteristics of a long-pass filter. FIG. 9 is a diagram showing angular dependence of transmittance of the long-pass filter. FIG. 10 is a diagram showing transmission characteristics of a conventional band-pass filter. FIG. 11 is a diagram showing angular dependence of transmittance of the conventional band-pass filter. FIG. 12 is a diagram showing absorption wavelengths of multiple kinds of gases.

As illustrated in FIG. 3, in the light guide part 13, infrared rays depicted with solid lines do not always travel parallel to the inner wall surface of the optical path but travel through repeated diagonal reflections. Therefore, light rays that enter the light receiver 4 are not vertical but are mainly angled. FIG. 7 shows distribution of incidence angles of infrared rays on the light receiver 4 (light receiving element) obtained by ray tracing simulation. Specifically, FIG. 7 shows the contribution ratio [%] of incidence angles θ [°] on the light receiver 4 to light intensity.

FIG. 6A shows an incidence angle θ. The incidence angle θ is a light incidence angle with respect to the perpendicular line to the light receiving surface of the light receiver 4. The results in FIG. 7 show that the vertical incidence components of light intensity (≈0°) account for a small percentage of the total light intensity and that the components corresponding to 30° to 35° (peak components) and greater angles account for half the total light intensity.

Herein, consider a case where the detection target gas G is the refrigerant R32. In this embodiment, the optical filter 3 is a long-pass filter having characteristics shown in FIG. 8 and FIG. 9. FIG. 8 shows, as the transmission characteristics of the long-pass filter, the transmittance [%] of the long-pass filter at incidence angles of 0°, 30°, 45°, and 60° with respect to light wavelengths [μm]. FIG. 9 shows, as angular dependence of transmittance of the long-pass filter, the transmittance [%] of the long-pass filter with respect to light incidence angles [°].

A configuration of a comparative example is described. In the comparative example, the optical filter 3 is a conventional band-pass filter having the characteristics shown in FIG. 10 and FIG. 11. FIG. 10 shows, as the transmission characteristics of the conventional band-pass filter, the transmittance [%] of the band-pass filter at incidence angles of 0°, 30°, 45°, and 60° with respect to light wavelengths [μm]. FIG. 11 shows, as angular dependence of transmittance of the conventional band-pass filter, the transmittance [%] of the band-pass filter with respect to light incidence angles [°].

The conventional band-pass filter in the comparative example is designed to transmit 9.1 μm, which is the absorption wavelength of R32 as a gas, at vertical incidence (incidence angle θ=0°). As shown in FIG. 10, as the incidence angle θ deviates from 0°, the center wavelength of R32 shifts toward the shorter wavelength side, and the transmittance [%] at 9.1 μm decreases. Therefore, when the conventional band-pass filter as the optical filter 3 is combined with the light guide part 13, the actual amount of infrared radiation received decreases below the designed value. As shown in FIG. 11, the transmittance [%] of the conventional band-pass filter in the comparative example rapidly decreases as the incidence angle θ exceeds 40°.

In contrast, as shown in FIG. 8, the transmittance [%] of the long-pass filter in this embodiment has a low level of incidence angle dependence at 9.1 μm, which is the absorption wavelength of R32. Therefore, the combination of the long-pass filter as the optical filter 3 and the light guide part 13 can receive various angles of light rays that reach the light receiver 4. Accordingly, high output signals for gas detection can be obtained (the concentration of the detection target gas G can be accurately detected). As shown in FIG. 9, as the incidence angle θ exceeds 40°, the transmittance [%] of the long-pass filter in this embodiment decreases more slowly than that of the conventional band-pass filter in the comparative example.

In a case where the detection target gas G is any of the refrigerants in Table II, the cut-on wavelength λo should be 5 to 8 μm, and the transmission wavelength λpass should be 7 to 12 μm, as the transmission characteristics of the long-pass filter at the incidence angle θ of 0°. Herein, λo and λpass should satisfy λo<λpass. The cut-on wavelength λo is defined as the wavelength at which the transmittance [%] is 5%. The transmission wavelength λpass is defined as the wavelength region in which the transmittance is 70% or greater. The lower limit of the cut-on wavelength λo of the long-pass filter should be 5 μm, which is longer than the main absorption wavelength of carbon dioxide, 4 μm. The upper limit of the cut-on wavelength λo should be less than or equal to 8.5 μm, which is the main absorption wavelength of R1234yf. The lower limit of the transmission wavelength λpass should be greater than or equal to 6 μm, which is the absorption wavelength of water vapor. The upper limit of the transmission wavelength λpass should be less than or equal to 12 μm, which is the absorption wavelength of carbon dioxide. It is preferable that the cut-on wavelength λo of the long-pass filter be 7 to 8 μm and that the transmission wavelength λpass be 8 to 11 μm.

Since the use of the long-pass filter as the optical filter 3 widens the transmission bandwidth, there is concern that components other than the detection target gas G may affect detection signals (gas components other than the detection target gas G might be included in gas detection signals). FIG. 12 shows absorption wavelengths [μm] of multiple kinds of gases. As shown in FIG. 12, few kinds of gases in the wavelength region greater than or equal to 7.5 μm are possibly contained in a living space. Therefore, absorption by these kinds of gases neither gives great influence nor poses a practical problem.

The long-pass filter having the transmission characteristics of this embodiment is applicable to a non-contact temperature sensor or a human sensor. Long-pass filters for the optical filters 3 can be produced together with long-pass filters for temperature/human sensors. This enables reduction of deposition cost (production cost).

As described above, according to this embodiment, the optical gas sensor device 100 includes: the light source 2 that emits infrared radiation to the detection target gas G; the optical filter 3 that transmits infrared radiation having passed through the detection target gas G; the light receiver 4 that detects infrared radiation entering the light receiver 4 via the optical filter 3 and generates a detection signal; and the optical cover 1 that covers the light source 2, the optical filter 3, and the light receiver 4. The optical filter 3 is a long-pass filter that has a cut-on wavelength shorter than the center wavelength of the absorption wavelength band of the detection target gas G and has a transmission wavelength including the center wavelength. The optical cover 1 includes the pipe-shaped light guide part 13. The light guide part 13 guides infrared radiation entering from the light source 2 toward the light receiver 4 via the optical filter 3 by reflecting the infrared radiation on its inner surface. The light guide part 13 has a circular cross section perpendicular to an axial direction.

Therefore, in detecting the detection target gas G using infrared radiation passing through the light guide part 13, which is a reflective optical path, the optical filter 3 can reduce influence of the incidence angle [0] dependence of transmittance of the detection target gas G, and can increase output voltage of the light receiver 4. Accordingly, accuracy in detecting the detection target gas G can be increased.

Further, the detection target gas G is either a refrigerant consisting of a single kind of molecule that contains at least one fluorine atom or a mixture refrigerant consisting of multiple kinds of molecules each of which contains at least one fluorine atom and that have different structures from each other. Therefore, alternative refrigerants for CFCs that have an absorption wavelength with the center wavelength at around 9 μm can be accurately detected as the detection target gas G.

Further, the optical filter 3 has a cut-on wavelength in the range of 5 to 8 μm and a transmission wavelength in the range of 7 to 12 μm. The cut-on wavelength is shorter than the transmission wavelength. Thus, the optical filter 3 has filtering characteristics appropriate for alternative refrigerants for CFCs and contributes to increasing detection accuracy of alternative refrigerant for CFCs as the detection target gas G.

Further, the optical gas sensor device 100 includes the board 6 on which the light source 2, the light receiver 4, and the optical cover 1 are mounted. Therefore, the light source 2, the light receiver 4, and the optical cover 1 can be precisely and securely disposed and fixed. This contributes to further enhancing detection accuracy of the detection target gas G.

Further, the light guide part 13 includes the entrance part 131 through which infrared radiation emitted by the light source 2 enters. The entrance part 131 has a tapered shape, and the cross-sectional area of the entrance part 131 becomes smaller toward the light source 2 side along the axial direction. Such an entrance part 131 can increase the concentration degree of infrared radiation toward the light receiver 4.

Further, the light guide part 13 includes the exit part 132 from which the guided infrared radiation is emitted to the light receiver 4 via the optical filter 3. The exit part 132 has a tapered shape, and the cross-sectional area of the exit part 132 becomes smaller toward the light receiver 4 side along the axial direction. Such an exit part 132 can increase the concentration degree of infrared radiation toward the light receiver 4.

### Practical Example

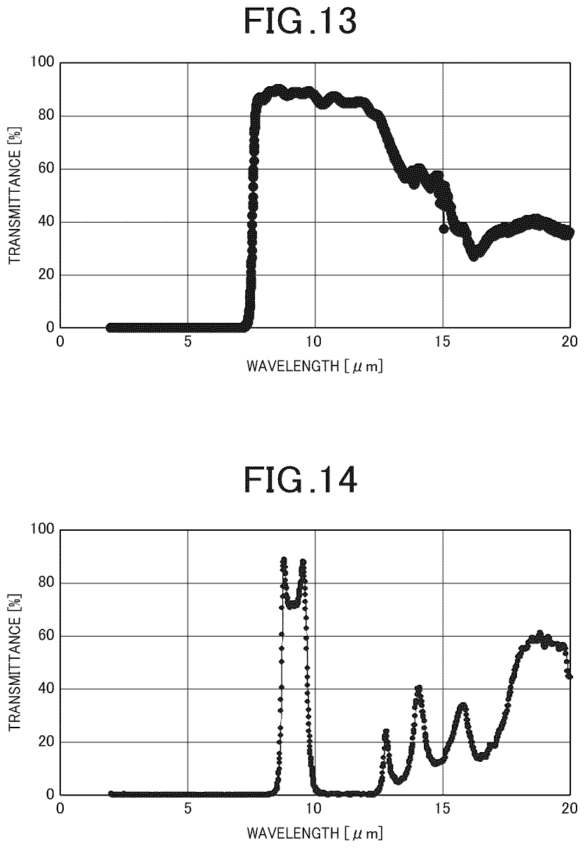

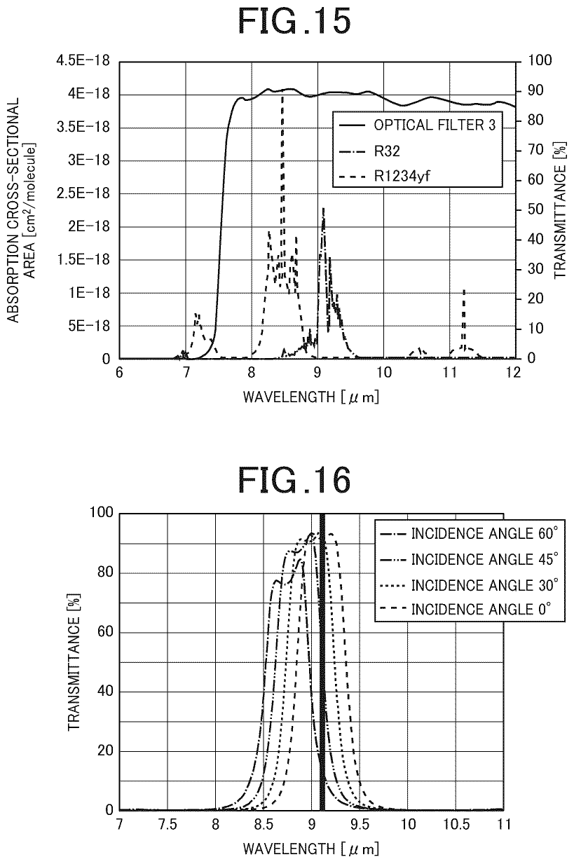

With reference to FIG. 13 to FIG. 15, a specific practical example of the above embodiment and a comparative example (referred to as a practical example 1 and a comparative example 1, respectively) are described. FIG. 13 is a diagram showing transmission characteristics of the optical filter 3 in the practical example 1. FIG. 14 is a diagram showing transmission characteristics of the optical filter in the comparative example 1. FIG. 15 is a diagram showing transmission characteristics of the optical filter 3 in the practical example 1 and absorption spectra of R32 and R1234yf.

The optical gas sensor device 100 that includes the optical filter 3 at the position shown in FIG. 6A is used. The chip size of the light source 2 is 2.5×0.4 mm, and the size of membrane M is 01.6 (diameter=1.6 mm). The chip of the light source 2 was die-bonded on the board 6, and thereafter, wire bonding was done on the pads P1 and P2 to obtain a predetermined connection. The resistance value of the light source 2 at normal temperature was 16Ω, and the applied voltage was 3.3 V.

The light receiver 4 is a MEMS thermopile and has a chip size of 1.3×0.7 mm, a height of 0.4 mm, and a membrane size of 0.71 mm. The resistance value of the light receiver 4 is 44 kΩ. The output signals of the light receiver 4 were amplified 70 times by an external amplifier circuit and the signal processor 5. The output signals of the light receiver 4 were transmitted from the optical gas sensor device 100 via an I2C interface and obtained as digital values. Specifically, the analog voltage output by the light receiver 4 is converted to a digital value by an AD converter in the signal processor 5. The influence of this digital value was calculated based on the full-scale voltage and resolution of the AD converter. Further, in consideration of the gain of 70 times, the digital value was then converted to a direct output voltage of the light receiver 4 and obtained as a digital value.

The optical filter 3 in the practical example 1 is a long-pass filter. As the transmission characteristics of the optical filter 3 in the practical example 1, FIG. 13 shows the transmittance [%] of the optical filter 3 in the practical example 1 with respect to wavelength [μm]. As the characteristics of the long-pass filter, the optical filter 3 in the practical example 1 has the cut-on wavelength of 7.5 μm and the maximum transmittance of 90%. The substrate of the optical filter 3 in the practical example 1 is made of silicon with the thickness of 0.32 mm. After the filter film (consisting of Ge and ZnS) was formed on the substrate, the substrate was diced into 3 mm square pieces.

The optical filter in the comparative example 1 is a band-pass filter. As the transmission characteristics of the optical filter 3 in the comparative example 1, FIG. 14 shows the transmittance [%] of the optical filter in the comparative example 1 with respect to wavelengths [μm]. The optical filter in the comparative example 1 has the following band-pass filter characteristics: the center wavelength of 9.1 μm, the maximum transmittance of 89%, the full width at half maximum (FWHM) of 1 μm, and the blocking in the range of 2 to 12 μm. The FWHM is used to indicate the spread of a spectrum and is the distance between two wavelengths each corresponding to 50% of the peak transmittance. The substrate of the optical filter in the comparative example 1 is made of silicon with the thickness of 0.34 mm. After the filter film (consisting of Ge and ZnS) was formed on the substrate, the substrate was diced into 3 mm square pieces.

The following Table IV shows the results of output voltages [mV] at several concentrations of R32 by the optical gas sensor device 100 that uses either the optical filter 3 in the practical example 1 or the optical filter in the comparative example 1. The concentrations of R32 were set to 5000, 15000, and 30000 ppm.

TABLE IV

| | Output voltage at each | | |
|---|---|---|---|
| | concentration of R32 [mV] | | |
| | 5000[ppm] | 15000[ppm] | 30000[ppm] |
| Practical example 1 | −0.098 | −0.207 | −0.305 |
| Comparative example 1 | −0.075 | −0.159 | −0.237 |
| Practical example 1/ | 1.31 | 1.30 | 1.29 |
| Comparative example 1 | | | |

In the case where the optical filter 3 of the practical example 1 was used, a higher output voltage was obtained at every concentration of R32 than in the case where the optical filter of the comparative example 1 was used. In the case where the optical filter 3 of the practical example 1 was used, the output voltages were about 1.3 times greater than the output voltages in the case where the optical filter of the comparative example 1 was used.

Since the transmission band of the optical filter 3 in the practical example 1 spreads to the longer wavelength side, the optical filter 3 does not only sense a specific refrigerant but can also detect various refrigerants and mixture refrigerants thereof. FIG. 15 shows, as the transmission characteristics of the optical filter 3 in the practical example 1, the transmittance [%] of the optical filter 3 in the practical example 1 with respect to wavelengths [μm]. FIG. 15 also shows, as the absorption spectra of R32 and R1234yf, the absorption cross-sectional areas [cm²/molecule] of R32 and R1234yf with respect to wavelengths [μm].

R32 and R1234yf are refrigerants constituting R454B, which is a typical example of a mixed refrigerant, and are mixed in the ratio of 68.9:31.1 by mass %, respectively. R32 and R1234yf both have the strongest absorption at the transmission band of the long-pass filter and can be measured with high sensitivity.

As described above, according to the optical filter 3 of the practical example 1, in detecting the detection target gas G using infrared radiation passing through the light guide part 13, which is a reflective light path, the optical filter 3 can increase detection accuracy of R32, R1234yf, and R454B as the detection target gas G.

### Second Embodiment

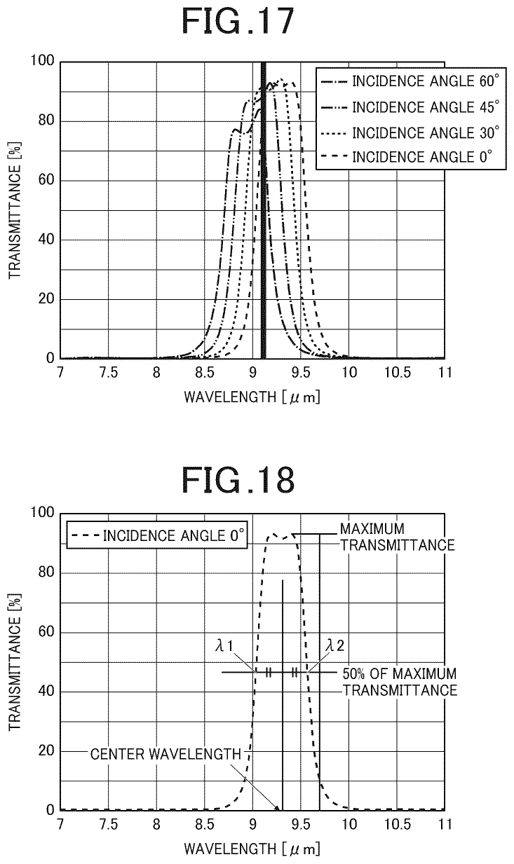

A second embodiment of the present invention is described with reference to FIG. 16 to FIG. 18. FIG. 16 is a diagram showing transmission characteristics of a conventional band-pass filter. FIG. 17 diagram is a showing transmission characteristics of a band-pass filter in this embodiment. FIG. 18 is a diagram showing transmission characteristics of a band-pass filter in an example and the center wavelength of transmittance.

In the above first embodiment, the optical filter 3/3a is a long-pass filter. In this embodiment, the optical filter 3/3a is a band-pass filter.

In this embodiment, the optical gas sensor device 100 is used as the apparatus configuration, as with the first embodiment. Therefore, description of components similar to the first embodiment is omitted, and the aspects different from the first embodiment, such as the optical filter 3, are mainly described.

For a conventional NDIR optical gas sensor device, the infrared transmission wavelength of a band-pass filter as an optical filter is set to a wavelength corresponding to maximum absorption in the absorption spectrum of a detection target gas. For example, the wavelength corresponding to maximum absorption in the absorption spectrum of methane is 3.3 μm as shown in FIG. 12, and the transmission wavelength of a conventional band-pass filter for detecting methane is set to 3.3 μm. Similarly, the wavelength corresponding to maximum absorption in the absorption spectrum of carbon dioxide is 4.26 μm as shown in FIG. 12, and the transmission wavelength of a conventional band-pass filter for detecting carbon dioxide is set to 4.26 μm.

The band-pass filter for detecting R32 as the detection target gas G is described. In FIG. 16, the wavelength range of transmittance [%] characteristics of a conventional band-pass filter with respect to infrared wavelengths [μm] in FIG. 10 is narrowed for viewability. As shown in FIG. 16, the conventional band-pass filter is designed to transmit 9.1 μm (bold line), which corresponds to maximum absorption in the absorption spectrum of R32 as the detection target gas, when infrared radiation vertically enters the light receiver (incidence angle θ=0°). More specifically, according to the conventional band-pass filter, the center wavelength of transmittance at the vertical incidence characteristic (incidence angle θ=0°) is set to 9.1 μm, which is the center wavelength of the absorption spectrum of R32.

The “center wavelength of transmittance” of the band-pass filter is described with reference to FIG. 18. FIG. 18 shows the greatest transmittance and wavelengths λ1 and λ2 corresponding to 50% of the greatest transmittance in transmittance [%] characteristics of an example band-pass filter with respect to infrared wavelengths [μm] at vertical incidence (the vertical incidence angle θ=0°). The center wavelength of transmittance of this band-pass filter is defined as the wavelength at the center of wavelengths λ1 and λ2 (=(the sum of wavelengths λ1 and λ2)/2).

As shown in FIG. 16, according to the conventional band-pass filter, as the infrared incidence angle increases, the transmittance [%] of 9.1 μm decreases. The wavelength of 9.1 μm corresponds to maximum absorption in the absorption spectrum of R32.

When such a conventional band-pass filter is used as the optical filter 3/3a of the optical gas sensor device 100, the center wavelength of transmittance deviates from the wavelength corresponding to maximum absorption in the absorption spectrum of R32 for angled infrared radiation emitted from the light guide part 13 (a pipe-shaped optical path). Accordingly, changes in light intensity owing to absorption by the gas R32 decrease.

FIG. 17 shows characteristics of transmittance [%] with respect to infrared wavelengths [μm] of the band-pass filter for R32 that is used as the optical filter 3/3a in this embodiment. The band-pass filter in this embodiment is designed such that the center wavelength of transmittance at vertical incidence is shifted to a longer wavelength side by a predetermined shift amount from the wavelength corresponding to maximum absorption (9.1 μm) in the absorption spectrum of R32, as compared with the conventional band-pass filter in FIG. 16. In monitoring designing and production of the band-pass filter of this embodiment to be used as the optical filter 3, the center wavelength of transmittance at vertical incidence is set to a wavelength longer than 9.1 μm. Accordingly, changes in light intensity owing to absorption by the gas R32 can be increased. As shown in FIG. 17, according to the band-pass filter of this embodiment, the transmittance [%] at 9.1 μm, which corresponds to maximum absorption in the absorption spectrum of R32, does not decrease when the infrared incidence angle increases.

The predetermined shift amount of the center wavelength of transmittance at vertical incidence (θ=0°) for the band-pass filter of this embodiment in FIG. 17 is +0.2 μm with respect to the wavelength corresponding to maximum absorption in the absorption spectrum of R32. An appropriate shift amount of the center wavelength of transmittance for the band-pass filter is in the range of +0.05 to +1 μm, or preferably, in the range of +0.1 to +0.4 μm, with respect to the wavelength corresponding to maximum absorption in the absorption spectrum of the detection target gas G.

According to this embodiment, the optical gas sensor device 100 includes: the light source 2 that emits infrared radiation to the detection target gas G; the optical filter 3/3a that transmits infrared radiation having passed through the detection target gas G; the light receiver 4 that detects infrared radiation entering the light receiver 4 through the optical filter 3/3a and generates a detection signal; and the optical cover 1 that covers the light source 2, the optical filter 3/3a, and the light receiver 4. The optical filter 3/3a is a band-pass filter. The center wavelength of transmittance at vertical incidence (θ=0°) of the optical filter 3/3a is shifted by a predetermined shift amount to a longer wavelength side from a wavelength corresponding to maximum absorption in the absorption spectrum of the detection target gas G. The optical cover 1 includes the pipe-shaped light guide part 13. The light guide part 13 guides infrared radiation entering from the light source 2 toward the light receiver 4 via the optical filter 3/3a by reflecting the infrared radiation on its inner surface. The light guide part 13 has a circular cross section perpendicular to an axial direction.

Thus, when the detection target gas G is present, the optical gas sensor device 1 can increase detection accuracy of the detection target gas G using infrared radiation passing through the reflective optical path, increase changes in light intensity, and increase outputs of the light receiver 4. Thus, influence of light intensity fluctuations caused by external disturbances is restrained, and detection performance is stabilized. Further, the power input to the light source 2 can be reduced. Further, the optical gas sensor device 100 can be made compact with a shorter optical path.

The predetermined shift amount is in the range of +0.05 to +1 μm with respect to the wavelength corresponding to maximum absorption in the absorption spectrum of the detection target gas G. Thus, when the detection target gas G is present, the optical gas sensor device 1 can further increase changes in light intensity and increase outputs of the light receiver 4, while restraining influence of light intensity fluctuations caused by external disturbances. Such an optical gas sensor device 1 can achieve stable detection performance and reduce power input to the light source 2.

The above embodiments are preferred examples of the optical gas sensor device according to the present invention and not intended to limit the present invention.

Although the light guide part 13 of the optical cover 1 in the above embodiments has a pipe shape and a circular cross section perpendicular to the axial direction, the present invention is not limited to this. The light guide part 13 may have a pipe shape with an oval cross section perpendicular to the axial direction, for example. As with the light guide part 13 having a circular cross section, the light guide part 13 having an oval cross section can reduce limitation of infrared reflection angles in the optical path and reduce loss of infrared light intensity caused by misalignment of the light source 2 and the light receiver 4. Thus, the optical gas sensor device 100 is resistant to misalignment and can retain increased detection accuracy of the detection target gas G.

Further, although the optical gas sensor device 100 in the above embodiments includes one set of the light source 2, the optical filter 3, the light receiver 4, and the light guide part 13, the present invention is not limited to this. The optical gas sensor device may include multiple sets of the light source 2, the optical filter 3, the light receiver 4, and the light guide part 13.

The detailed configuration and detailed operation of the optical gas sensor device 100 in the above embodiments may be appropriately modified without departing from the scope of the present invention.

### INDUSTRIAL APPLICABILITY

As described above, the optical gas sensor device according to the present invention is suitable for detecting gases, such as refrigerants.

### REFERENCE SIGNS LIST

100 Optical gas sensor device
G Gas
1 Optical cover
110A, 110B Cover parts
11 Gas introduction ports
111, 112, 113, 114 Gas Intake ports
13 Light guide part
12 Contamination filter
S1 Space
2 Light source
21 Light source layer
231, 232 Electrodes
P1, P2 Pads
M Membrane
3, 3a Optical filter
4 Light receiver
5 Signal processor
6 Board
7 Connector
8 Circuit elements
81 Switch

1. An optical gas sensor device comprising:
a light source that emits infrared radiation to a detection target gas;
an optical filter that transmits infrared radiation having passed through the detection target gas, the optical filter being a long-pass filter that has a cut-on wavelength shorter than a center wavelength of an absorption wavelength band of the detection target gas and a transmission wavelength including the center wavelength;
a light receiver that detects infrared radiation entering the light receiver via the optical filter and generates a detection signal; and
an optical cover that covers the light source, the optical filter, and the light receiver,
wherein the optical cover includes a pipe-shaped light guide part that guides infrared radiation entering from the light source to the light receiver via the optical filter by reflecting the infrared radiation on an inner surface and that has a circular or oval cross section perpendicular to an axial direction.

2. The optical gas sensor device according to claim 1, wherein the detection target gas is either a refrigerant consisting of a single kind of molecule that contains at least one fluorine atom or a mixture refrigerant consisting of multiple kinds of molecules each of which contains at least one fluorine atom and that have different structures from each other.

3. The optical gas sensor device according to claim 1, wherein:
the cut-on wavelength of the optical filter is 5 to 8 μm,
the transmission wavelength of the optical filter is 7 to 12 μm, and
the cut-on wavelength is shorter than the transmission wavelength.

4. An optical gas sensor device comprising:
a light source that emits infrared radiation to a detection target gas;
an optical filter that transmits infrared radiation having passed through the detection target gas, the optical filter being a band-pass filter, a center wavelength of transmittance at vertical incidence (θ=0°) of the optical filter being shifted by a predetermined shift amount to a longer wavelength side from a wavelength corresponding to maximum absorption in an absorption spectrum of the detection target gas;
a light receiver that detects infrared radiation entering the light receiver via the optical filter and generates a detection signal; and
an optical cover that covers the light source, the optical filter, and the light receiver,
wherein the optical cover includes a pipe-shaped light guide part that guides infrared radiation entering from the light source to the light receiver via the optical filter by reflecting the infrared radiation on an inner surface and that has a circular or oval cross section perpendicular to an axial direction.

5. The optical gas sensor device according to claim 4, wherein the predetermined shift amount is +0.05 to +1 μm with respect to the wavelength corresponding to maximum absorption in the absorption spectrum of the detection target gas.

6. The optical gas sensor device according to claim 1, further comprising a board on which the light source, the light receiver, and the optical cover are mounted.

7. The optical gas sensor device according to claim 1, wherein:
the light guide part includes an entrance part through which infrared radiation emitted by the light source enters, and
the entrance part has a tapered shape, and a cross-sectional area of the entrance part becomes smaller toward the light source along the axial direction.

8. The optical gas sensor device according to claim 1, wherein:
the light guide part includes an exit part from which the guided infrared radiation is emitted to the light receiver via the optical filter, and
the exit part has a tapered shape, and a cross-sectional area of the exit part becomes smaller toward the light receiver along the axial direction.

9. The optical gas sensor device according to claim 4, further comprising a board on which the light source, the light receiver, and the optical cover are mounted.

10. The optical gas sensor device according to claim 4, wherein:
the light guide part includes an entrance part through which infrared radiation emitted by the light source enters, and
the entrance part has a tapered shape, and a cross-sectional area of the entrance part becomes smaller toward the light source along the axial direction.

11. The optical gas sensor device according to claim 4, wherein:
the light guide part includes an exit part from which the guided infrared radiation is emitted to the light receiver via the optical filter, and
the exit part has a tapered shape, and a cross-sectional area of the exit part becomes smaller toward the light receiver along the axial direction.
